(19) United States
(12) Patent Application Publication
(10) Pub. No.: US 2008/0135318 A1
(43) Pub. Date: Jun. 12, 2008

(54) Snow eliminator

(76) Inventor: Terry P. McDonough, Talent, OR (US)

Correspondence Address: R. Keith Harrison, 2139 East Bert Kouns, Shreveport, LA, 71105, US

(21) Appl. No.: 11/394,688

(22) Filed: Apr. 1, 2006

(51) Int. Cl. B62M 27/02

(52) U.S. Cl. 180/182

(57) ABSTRACT

A snow eliminator is disclosed. An illustrative embodiment of the snow eliminator includes a base plate; multiple snow drop openings extending through the base plate in spaced-apart, generally aligned relationship to each other; and multiple grip flanges extending from the base plate at the plurality of snow drop openings, respectively. A snowmobile is also disclosed.

### FIELD

The present invention relates to devices suitable for removing-snow from snowmobiles and the like. More particularly, the present invention relates to a snow eliminator which can function as a running board on a snowmobile to facilitate the removal of snow from the snowmobile.

### BACKGROUND

Conventional snowmobiles typically include a frame on which is mounted a motor-driven traction belt and front skids to facilitate steering of the snowmobile. A chassis, fitted with a seat, is mounted on the frame. Running boards typically extend from the frame on opposite sides of the chassis to support the feet of a snowmobile rider as the rider sits on the seat.

When a snowmobile is driven in deep snow conditions, such as in off-road areas or trails, for example, a large quantity of snow tends to accumulate on the running boards of snowmobiles. The running boards are typically a solid construction, and therefore, the accumulated snow must be periodically removed from the running boards typically by sliding or knocking the snow off the side edges of the running boards. Since the snowmobile rider's feet are supported on the running boards during operation of the snowmobile, the snow frequently becomes packed, and therefore, laborious and time-consuming to remove.

### SUMMARY

The present invention is generally directed to a snow eliminator. An illustrative embodiment of the snow eliminator includes a base plate; multiple snow drop openings extending through the base plate in spaced-apart, generally aligned relationship to each other; and multiple grip flanges extending from the base plate at the plurality of snow drop openings, respectively.

The present invention is further generally directed to a snowmobile. An illustrative embodiment of the snowmobile includes a snowmobile frame; an engine provided on the snowmobile frame; a traction belt drivingly engaged by the engine; at least one steering skid provided on the snowmobile frame; a snowmobile chassis provided on the snowmobile frame; and a pair of snow eliminators provided on the snowmobile frame. Each of the pair of snow eliminators includes a base plate; multiple snow drop openings extending through the base plate in spaced-apart, generally aligned relationship to each other; and multiple grip flanges extending from the base plate at the snow drop openings, respectively.

### BRIEF DESCRIPTION OF THE DRAWINGS

The invention will now be described, by way of example, with reference to the accompanying drawings, in which:

FIG. 1 is a rear perspective view of an illustrative embodiment of a snow eliminator, provided on a snowmobile (in phantom);

FIG. 2 is a front perspective view of an illustrative embodiment of a snow eliminator, provided on a snowmobile (in phantom);

FIG. 3A is an interior side view, partially in section, of an illustrative embodiment of a snow eliminator; and

FIG. 3B is an exterior side view of an illustrative embodiment of a snow eliminator.

### DETAILED DESCRIPTION

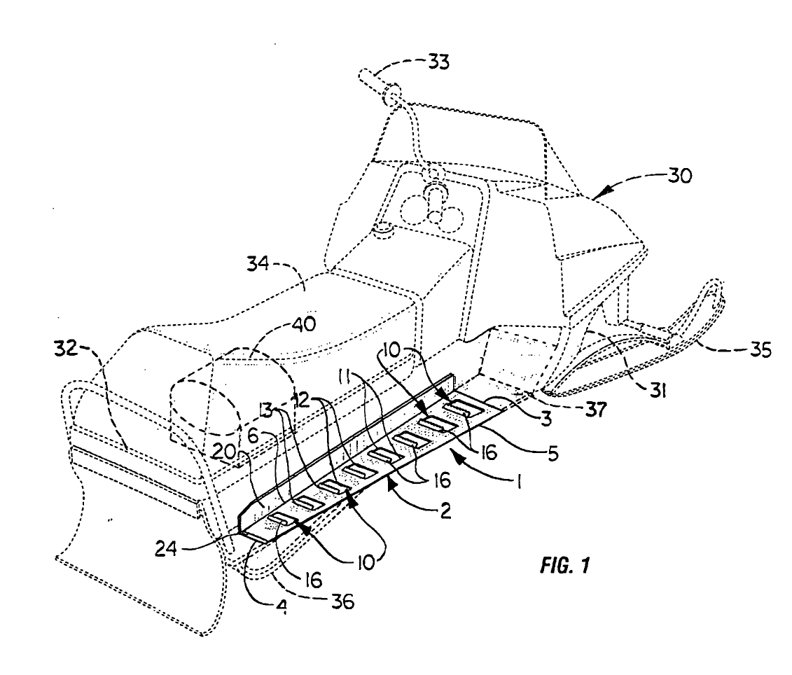

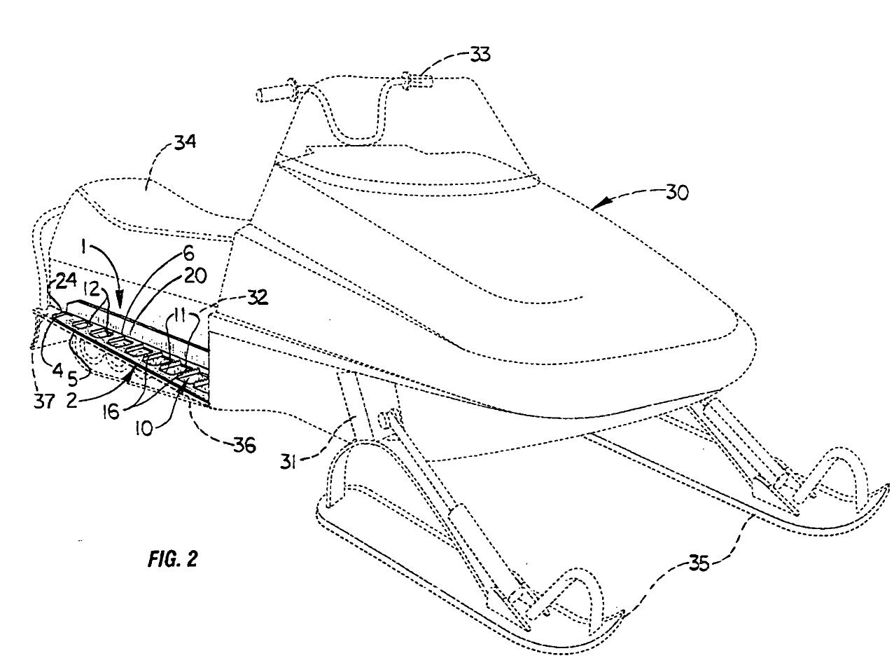

Referring to the drawings, an illustrative embodiment of a snow eliminator is generally indicated by reference numeral 1. As illustrated in FIGS. 1 and 2, paired snow eliminators 1 may be mounted on a snowmobile 30, such as in the respective running board positions of the snowmobile 30, for example. The snowmobile 30 may be of conventional design and, as illustrated in phantom in FIGS. 1 and 2, typically includes a snowmobile frame 31. A snowmobile chassis 32 is provided on the snowmobile frame 31. Handlebars 33 are provided on the snowmobile chassis 32 and are adapted to steer a steering skid 35 or pair of steering skids 35 mounted on the front end portion of the snowmobile frame 31. A seat 34 is provided on the snowmobile chassis 32, behind the handlebars 33. Beneath the snowmobile chassis 32, a traction belt 36 is drivingly engaged by an engine 40 (FIG. 1), typically in conventional fashion, mounted on the snowmobile frame 31. The traction belt 36 is adapted to propel the snowmobile 30 on a snow or ice surface (not illustrated) responsive to operation of the engine 40.

Running board supports 37 typically extend outwardly from the snowmobile frame 31, on respective sides of the snowmobile chassis 32. Accordingly, each snow eliminator 1 is suitable to be mounted on a corresponding running board support 37 of the snowmobile 30 to prevent accumulation of snow (not illustrated) on the sides of the snowmobile 30, particularly during operation of the snowmobile 30 in deep snow conditions, as will be hereinafter further described. It is to be understood that the foregoing description of the snowmobile 30 is illustrative only and that the snow eliminator or eliminators 1 may be mounted on a snowmobile 30 having a design which varies from that heretofore described. Furthermore, the snow eliminator or eliminators 1 are suitable for a variety of alternative applications, as will be apparent from the description of the snow eliminator 1 which is set forth herein below.

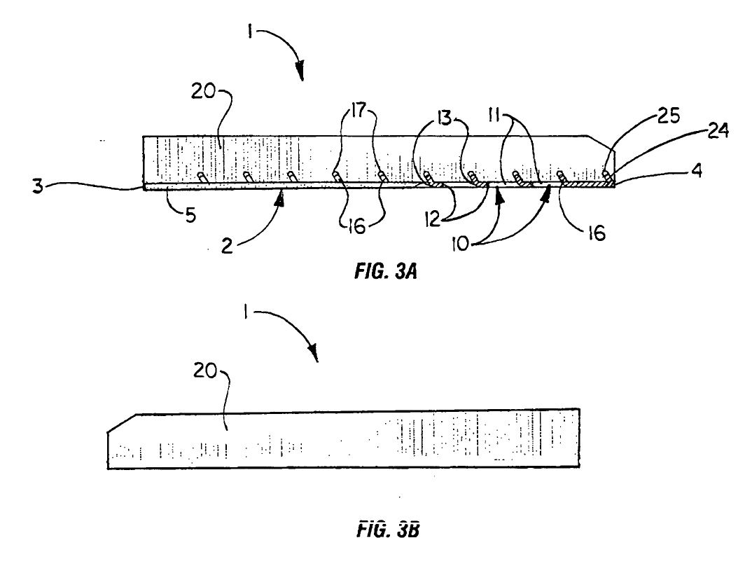

The snow eliminators 1 adapted for mounting on the respective running board supports 37 of the snowmobile 30 may be mirror images of each other, such as the snow eliminator 1 illustrated in FIGS. 1 and 2 (which is adapted for mounting on the right-hand running board support 37 of the snowmobile 30) and the snow eliminator 1 illustrated in FIGS. 3A and 3B (which is adapted for mounting on the left-hand running board support, not illustrated, of the snowmobile 30). Each snow eliminator 1 typically includes a base plate 2 which may have a generally elongated, rectangular shape. The base plate 2 is typically stainless steel or aluminum, although other metals or rigid, durable materials may alternatively be used. The base plate 2 typically has a plate end 3 and a plate end 4 which are spaced-apart with respect to each other. The base plate 2 typically further includes a plate edge 5 and a plate edge 6 which extend between the plate end 3 and the plate end 4, in spaced-apart relationship with respect to each other.

The base plate 2 may have substantially the same width between the plate end 3 and the plate end 4. Alternatively, the base plate 2 may gradually widen from the plate end 4 to the plate end 3, as illustrated, or alternatively, from the plate end 3 to the plate end 4, imparting a generally trapezoidal shape to the base plate 2. In some embodiments of the snow eliminator 1, a side plate 20 extends from the plate edge 6 of the base plate 2. The base plate 2 may be fabricated in any desired size and shape to generally conform to the size and shape of the running board support 37 of the snowmobile 30. The side plate 20 may be generally coextensive with the base plate 2 and is typically disposed in generally perpendicular relationship with respect to the plane of the base plate 2. The side plate 20 may be used to facilitate attachment of the snow eliminator 1 to the running board support 37 of the snowmobile 30.

Multiple snow drop openings 10 extend through the base plate 2, in spaced-apart relationship to each other between the plate end 3 and the plate end 4. The snow drop openings 10 may be arranged in a single row between the plate edges 5, in generally aligned relationship to each other. Alternatively, multiple adjacent rows of the snow drop openings 10 may be arranged between the plate edges 5. In some embodiments of the snow eliminator 1, each snow drop opening 10 has a generally rectangular shape and includes a pair of generally parallel, spaced-apart opening side edges 11 as well as an opening edge 12 and an opening edge 13 which are disposed in generally parallel, spaced-apart relationship with respect to each other and generally perpendicular relationship to the opening side edges 11. In other embodiments of the snow eliminator 1, each snow drop opening 10 has a circular, triangular or other shape. The snow drop openings 10 may have the same width or vary in width.

As illustrated in FIG. 3A, a grip flange 16 extends upwardly from the opening edge 13 of each snow opening 10, adjacent to the corresponding snow drop opening 10. In some embodiments of the snow eliminator 1, each grip flange 16 is disposed in generally perpendicular relationship to the plane of the base plate 2. In other embodiments of the snow eliminator 1, as illustrated in FIG. 3A, each grip flange 16 angles away from the adjacent snow drop opening 10. In still other embodiments of the snow eliminator 1, each grip flange 16 angles toward the adjacent snow drop opening 10. Multiple flange teeth 17, the purpose of which will be hereinafter described, are provided on each grip flange 16.

In some embodiments of the snow eliminator 1, a terminal flange 24 extends from the plate end 4 of the base plate 2. As illustrated in FIG. 3A, the terminal flange 24 may be disposed at generally the same angle with respect to the base plate 2 as the grip flanges 16. Multiple flange teeth 25 may be provided on the terminal flange 24. The terminal flange 24 enhances the structural rigidity of the base plate 2 as well as enhances gripping capability of a rider's foot on the snow eliminator 1.

In typical application, snow eliminators 1 are mounted on the respective running board supports 37 of the snowmobile 30. Each snow eliminator 1 may be attached to the corresponding running board support 37 using any suitable technique known by those skilled in the art including but not limited to threaded fasteners, welding or both. Each snow eliminator 1 may be factory-installed on the snowmobile frame 31, or alternatively, may be retrofitted to the snowmobile frame 31. In the latter case, the conventional running boards (not illustrated) which are attached to the running board support 37 may be removed from each running board support 37 and replaced with the snow eliminators 1. Alternatively, the conventional running boards may remain on the respective running board supports 37, in which case the snow eliminators 1 are bolted or otherwise attached to the running boards and enhance the structural strength of the running boards.

During operation of the snowmobile 30, a snowmobile driver (not illustrated), alone or with one or more passengers (not illustrated), sits on the seat 34 and grasps the handlebars 33 to turn the steering skid or skids 35 and steer the snowmobile 30. The snowmobile riders' feet (not illustrated) rest on the respective snow eliminators 1. A hand-operated throttle (not illustrated) is typically provided on the handlebars 33 and connected to the engine (not illustrated) of the snowmobile 30 to facilitate rotation of the traction belt 36 on a snow or ice surface (not illustrated). As the snowmobile 30 traverses deep snow (not shown), such as in off-road areas or trails, for example, a large quantity of snow tends to accumulate on the portions of snowmobile 30 which contact the snow. In the event that the rider or riders of the snowmobile 30 dismount the snowmobile 30 and walk through the snow, the snow accumulates on the rider's feet. Upon the rider's subsequent mounting of the snowmobile 30, this snow is transferred from the rider's foot to the snow eliminator 1, where the snow has a tendency to accumulate. However, the rider need only move his or her foot back and forth in a forward and rearward motion on the snow eliminator 1 in order to remove the accumulated snow from the rider's foot and the snow eliminator 1, since the snow contacts the flange teeth 17 on each of the grip flanges 16 such that the flange teeth 17 dislodge the snow from the rider's feet and the snow eliminator 1 and the snow falls through the snow drop openings 12. Moreover, the flange teeth 17 of each grip flange 16 enhance non-slip capability of the rider's foot on the snow eliminator 1.

While the preferred embodiments of the invention have been described above, it will be recognized and understood that various modifications can be made in the invention and the appended claims are intended to cover all such modifications which may fall within the spirit and scope of the invention.

What is claimed is:

1. A snow eliminator, comprising:
a base plate;
a plurality of snow drop openings extending through said base plate in spaced-apart, generally aligned relationship to each other; and
a plurality of grip flanges extending from said base plate at said plurality of drop openings, respectively.

2. The snow eliminator of claim 1 wherein said plurality of snow drop openings are arranged in single-file relationship to each other.

3. The snow eliminator of claim 1 further comprising a side plate carried by said base plate.

4. The snow eliminator of claim 3 wherein said side plate is disposed in generally perpendicular relationship to said base plate.

5. The snow eliminator of claim 1 wherein said base plate has a generally elongated, rectangular configuration with first and second plate ends disposed in spaced-apart relationship to each other and first and second plate edges disposed in spaced-apart relationship to each other.

6. The snow eliminator of claim 1 wherein each of said plurality of snow drop openings comprises first and second opening edges disposed in spaced-apart relationship to each other and first and second opening side edges disposed in spaced-apart relationship to each other and in generally perpendicular relationship to said first and second opening edges.

7. The snow eliminator of claim 6 wherein each of said plurality of grip flanges extends from said first opening edge of a corresponding one of said plurality of snow drop openings.

8. The snow eliminator of claim 1 further comprising a plurality of flange teeth provided on each of said plurality of grip flanges.

9. A snow eliminator, comprising:
a base plate having first and second plate ends disposed in spaced-apart relationship to each other and first and second plate edges extending between said first and second plate ends in spaced-apart relationship to each other;
a plurality of snow drop openings extending through said base plate in spaced-apart, generally aligned, single-file relationship to each other;
a plurality of grip flanges extending from said base plate at said plurality of drop openings, respectively; and
a terminal flange extending from said first plate end of said base plate.

10. The snow eliminator of claim 9 further comprising a side plate carried by said base plate along said first plate edge.

11. The snow eliminator of claim 10 wherein said side plate is disposed in generally perpendicular relationship to said base plate.

12. The snow eliminator of claim 9 wherein each of said plurality of snow drop openings comprises first and second opening edges disposed in spaced-apart relationship to each other and first and second opening side edges disposed in spaced-apart relationship to each other and in generally perpendicular relationship to said first and second opening edges.

13. The snow eliminator of claim 12 wherein each of said plurality of grip flanges extends from said first opening edge of a corresponding one of said plurality of snow drop openings.

14. The snow eliminator of claim 13 further comprising a plurality of flange teeth provided on each of said plurality of grip flanges.

15. A snowmobile, comprising:
a snowmobile frame;
an engine carried by said snowmobile frame;
a traction belt drivingly engaged by said engine;
at least one steering skid carried by said snowmobile frame;
a snowmobile chassis carried by said snowmobile frame; and
a pair of snow eliminators carried by said snowmobile frame, each of said pair of snow eliminators comprising a base plate; a plurality of snow drop openings extending through said base plate in spaced-apart, generally aligned relationship to each other; and a plurality of grip flanges extending from said base plate at said plurality of snow drop openings, respectively.

16. The snowmobile of claim 15 wherein said plurality of snow drop openings are arranged in single-file relationship to each other.

17. The snow eliminator of claim 15 further comprising a side plate carried by said base plate in generally perpendicular relationship to said base plate.

18. The snow eliminator of claim 15 wherein each of said plurality of snow drop openings comprises first and second opening edges disposed in spaced-apart relationship to each other and first and second opening side edges disposed in spaced-apart relationship to each other and in generally perpendicular relationship to said first and second opening edges.

19. The snow eliminator of claim 18 wherein each of said plurality of grip flanges extends from said first opening edge of a corresponding one of said plurality of snow drop openings, and further comprising a plurality of flange teeth provided on each of said plurality of grip flanges.

20. The snow eliminator of claim 15 further comprising a terminal flange having a plurality of flange teeth carried by said base plate.
